(19) United States
(12) Patent Application Publication
(10) Pub. No.: US 2011/0227550 A1
(43) Pub. Date: Sep. 22, 2011

(54) MODULATION SCHEME USING A SINGLE COMPARATOR FOR CONSTANT FREQUENCY BUCK BOOST CONVERTER

(75) Inventors: MICHAEL M. WALTERS, APEX, NC (US); WEIHONG QIU, SAN JOSE, CA (US)

(73) Assignee: INTERSIL AMERICAS INC., MILPITAS, CA (US)

(21) Appl. No.: 12/898,971

(22) Filed: Oct. 6, 2010

Related U.S. Application Data
(60) Provisional application No. 61/315,587, filed on Mar. 19, 2010.

(51) Int. Cl. G05F 1/618

(52) U.S. Cl. 323/283

(57) ABSTRACT

A buck boost converter generates an output voltage responsive to an input voltage and at least one switching control signal in a buck mode of operation, a boost mode of operation and a buck-boost mode of operation. Control logic generates the at least one switching control signal responsive to the output voltage, a reference voltage, and a sensed voltage associated with an inductor current of the buck boost converter. The sensed voltage associated with the inductor current enables the control logic to generate the at least one switching control signal in a selected one of the buck mode of operation, the boost mode of operation and the buck-boost mode of operation.

### CROSS-REFERENCE TO RELATED APPLICATIONS

This application claims benefit from U.S. Provisional Application No. 61/315,587, filed Mar. 19, 2010 and entitled MODULATION SCHEME USING A SINGLE COMPARATOR FOR CONSTANT FREQUENCY BUCK BOOST CONVERTER, which is incorporated herein by reference.

### BRIEF DESCRIPTION OF THE DRAWINGS

For a more complete understanding, reference is now made to the following description taken in conjunction with the accompanying Drawings in which:

FIG. 1 is a schematic diagram of a buck boost converter;

FIG. 2 illustrates a first embodiment of a modulation scheme for a buck boost converter;

FIG. 3 illustrates various waveforms associated with the operation of the circuit of FIG. 2 in buck mode;

FIG. 4 illustrates various waveforms associated with the operation of the circuit of FIG. 2 in the boost mode;

FIG. 5 illustrates various waveforms associated with the operation of the circuit of FIG. 2 in buck boost mode;

FIG. 6 illustrates an alternative embodiment of a modulation scheme for a buck boost converter;

FIG. 7a illustrates waveforms associated with the circuit of FIG. 6 in the buck mode;

FIG. 7b illustrates waveforms associated with the circuit of FIG. 6 in the buck mode with no clock signal;

FIG. 8a illustrates waveforms associated with the circuit of FIG. 6 in the boost mode;

FIG. 8b illustrates waveforms associated with the circuit of FIG. 6 in the boost mode with no clock signal;

FIG. 9 illustrates waveforms associated with the circuit of FIG. 6 in the buck boost mode;

FIG. 10 is an illustration of a further embodiment of a modulation scheme for use with a buck boost converter;

FIG. 11 illustrates waveforms associated with the circuit of FIG. 10 in the buck mode of operation;

FIG. 12 illustrates waveforms associated with the operation of the circuit of FIG. 10 in the boost mode of operation; and

FIG. 13 illustrates waveforms associated with the operation of the circuit of FIG. 10 in buck boost mode of operation.

### DETAILED DESCRIPTION

Referring now to the drawings, wherein like reference numbers are used herein to designate like elements throughout, the various views and embodiments of a modulation scheme using a single comparator for constant frequency buck boost converter are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Existing methods for modulating constant frequency buck boost converters involve the use of two level shifted ramps or two level shifted COMP signals from error amplifiers. Each of these methods do not provide entirely satisfactory operation and have issues with accuracy, fidelity and low bandwidth issues. Thus, there is a need for an improved buck boost regulator control scheme that overcomes the issues inherent in existing implementations.

Referring now to FIG. 1, there is illustrated a general schematic diagram of a buck boost regulator 102. The input voltage V_{IN} is applied at node 104. A transistor 106 has its drain/source path connected between node 104 and node 108. A transistor 110 has its drain/source path connected between node 108 and ground. An inductor 112 is connected between node 108 and node 114. A transistor 116 has its drain/source path connected between node 114 and ground. Transistor 118 has its drain/source path connected between the output voltage node V_{OUT} 120 and node 114. Each of the power transistors 106, 110, 114 and 116 are under the control of control logic 122. The control logic 122 may take any number of configurations, several of which will be described more fully herein below. In addition to the switching of the MOS transistor described herein above, a diode may be substituted for the MOS transistor in certain configurations.

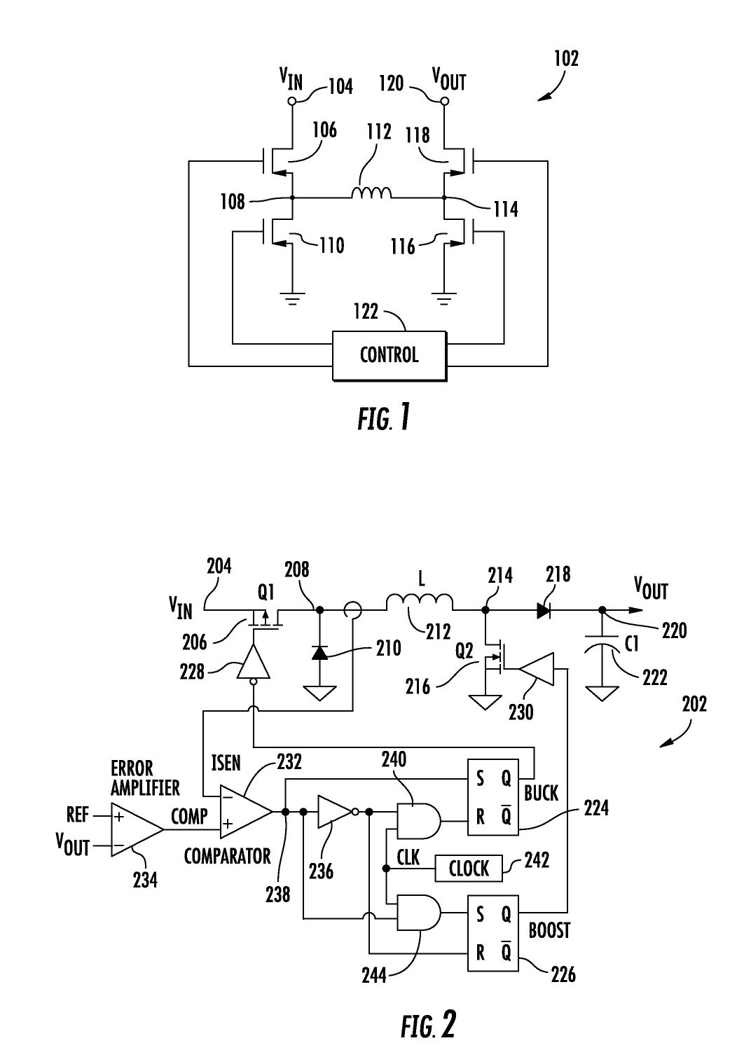

Referring now to FIG. 2, there is illustrated a first embodiment of a simple modulation technique for implementation within the control logic 122 for controlling the non-inverting buck boost converter 202. The buck boost converter 202 includes an input voltage node 204 to which the input voltage V_{IN} is applied. A transistor 206 has its source/drain path connected between node 204 and node 208. A diode 210 has its cathode connected to node 208 and its anode connected to ground. An inductor 212 is connected between node 208 and node 214. A second switching transistor 216 has its drain/source path connected between node 214 and ground. A diode 218 has its anode connected to node 214 and its cathode connected to the output voltage node 220 from which the output voltage V_{OUT} is provided. A capacitor 222 is connected between the output voltage node 220 and ground.

Control signals are provided to the gates of transistors 206 and 216 from drivers 228 and 230, respectively that are connected to the Q outputs of SR latches 224 and 226. The Q output of SR latch 224 is connected to the inverting input of an amplifier driver 228. The output of amplifier driver 228 is connected to the gate of transistor 206. The Q output of SR latch 226 is provided to the input of amplifier driver 230 whose output is connected to the gate of transistor 216. The SR latch 224 provides the buck control signals to transistor 206 while SR latch 226 provides the boost control signals to transistor 216.

A comparator 232 is connected to receive a current sense signal ISEN from node 208. Any number of current sensing devices may be used for sensing the current provided to the inverting input of the comparator 232. The ISEN current sense signal is provided to the inverting input of comparator 232. The non-inverting input of comparator 232 is connected to the output of an error amplifier 234. The inverting input of error amplifier 234 is connected to receive the output voltage signal V_{OUT} from node 220. The non-inverting input of the error amplifier 234 is connected to a reference voltage REF. The output of comparator 232 is connected to the input of an inverter 236 at node 238. The S input of latch 224 is also connected to the output of the comparator 232 at node 238. The output of inverter 136 is provided as a first input to AND gate 240. The other input of AND gate 240 is connected to receive a clock signal from clock circuit 242. The output of AND gate 240 is connected to the R input of SR latch 224. The output of inverter 236 is also connected to the R input of SR latch 226. The S input of SR latch 226 is connected to the output of AND gate 244. A first input of AND gate 244 is connected to receive a clock signal from clock 242 and its other input is connected to the output of comparator 232 at node 238.

When the input voltage V_{IN} at node 204 is greater than the output voltage V_{OUT} at node 220, the buck boost regulator 202 operates in a buck mode of operation with transistor 216 turned off and transistor 206 modulated to regulate the output voltage V_{OUT} at node 220. When the input voltage V_{IN} at node 204 is less than the output voltage V_{OUT} at node 220, the buck boost regulator 202 operates in the boost mode of operation with transistor 206 turned on and transistor 216 modulated to regulate the output voltage V_{OUT}. When the input voltage V_{IN} and the output voltage V_{OUT} are roughly equal, the buck boost regulator operates in a buck boost mode of operation and both transistors are modulated to regulate the output voltage V_{OUT} at node 220.

While switches 206 and 216 are illustrated as MOSFET circuits, any type of controlled switch such as bipolar junction transistor, relay or other may alternatively be utilized. The diodes 210 and 218 can be replaced with synchronous rectifier without altering the operation of the buck boost regulator 202. The inductor current feedback signal ISEN provided from node 208 can be directly scaled to the inductor current or synthesized with a capacitor and trans conductance amplifier as described in U.S. Pat. No. 7,132,820, issued Nov. 7, 2006 which is incorporated herein by reference.

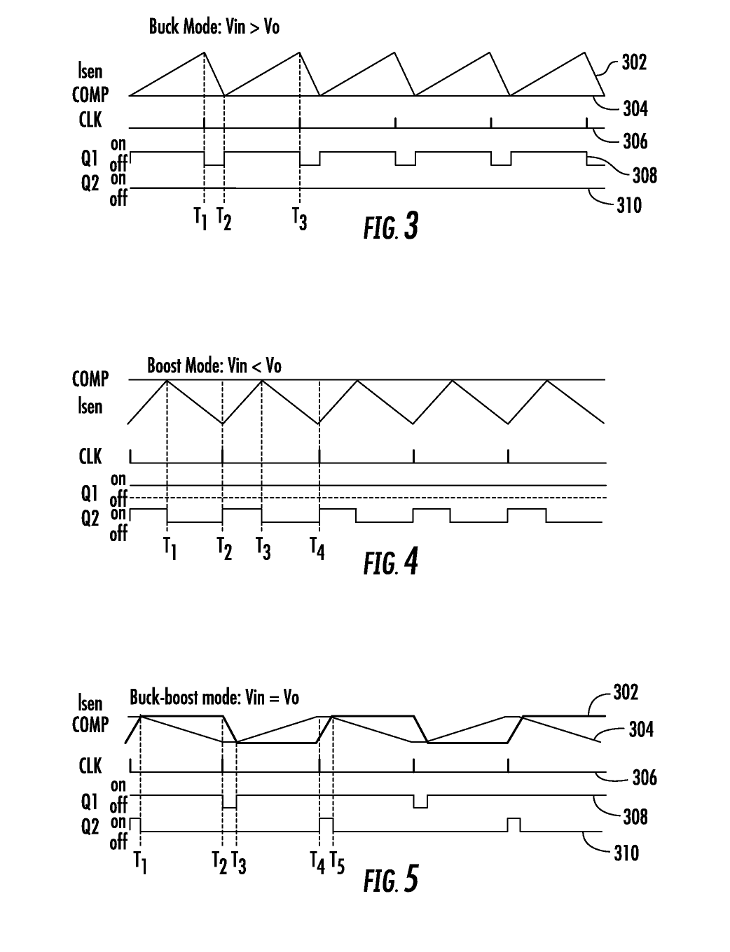

Referring now to FIG. 3, there is illustrated the sense current ISEN 302 at node 208, the output of COMP 304 of the error amplifier 234, the output CLK 306 of the clock circuit 242 and the “on” or “off” state of the transistors 206 and 216 at 308 and 310, respectively. During the buck mode of operation, the input voltage V_{IN} at node 204 is greater than the output voltage V_{OUT} at node 220. Initially, it is assumed that the transistor 206 is turned on, the transistor 216 is “off,” the inductor current is increasing and the inductor current feedback signal ISEN at node 208 is greater than the error amplifier output COMP. The output of the comparator 232 is low so that when the clock signal 306 pulses at, for example, time T₁, the buck SR flip-flop 224 reverts and turns off transistor 206. The inductor current through inductor 212 will then begin decreasing until the ISEN signal 302 becomes less than the COMP signal 304 at time T₂. The inductor current then increases from time T₂ to time T₃ until occurrence at T₃ of the next clock pulse within the clock signal 306. The boost SR flip-flop 226 remains in a reset mode with transistor 216 turned off during the buck mode of operation. This is caused by the comparator 232 being “low” during a clock pulse on clock signal 306.

Referring now to FIG. 4, there is illustrated the operation of the waveforms within the buck boost converter of FIG. 2 during the boost mode of operation when the input voltage V_{IN} is less than the output voltage V_{OUT}. Initially, at time T₁, assume that the transistor 206 is turned on, the transistor 216 is turned off and the inductor current feedback signal ISEN at node 208 is greater than the error amplifier output COMP. The output of the comparator 232 is “low” so that when the clock pulse within the clock signal 306 occurs at time T₂, the boost SR flip-flop 226 is set and transistor 216 is turned on. The inductor current then begins increasing as does the ISEN signal 302 from time T₂ to time T₃ until the ISEN signal 302 becomes greater than the COMP signal 304 at time T₃. This causes the comparator 232 to go “low” and reset the boost SR flip-flop 226 and turn off transistor 216. The inductor current then begins decreasing which decreases the level of the ISEN signal 302 from time T₃ to T₄. The cycle then repeats itself. The buck SR flip-flop 224 remains set with transistor 206 turned on in this mode of operation due to the comparator 238 being “high” during the clock pulse signals from the clock circuit 242.

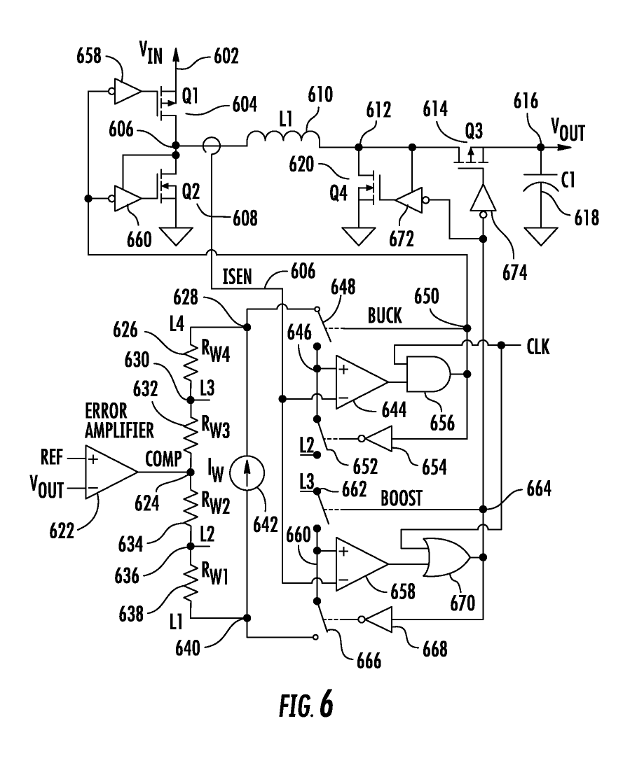

Referring now to FIG. 5, there is illustrated the buck boost mode of operation of the circuit of FIG. 2 wherein the input voltage V_{IN} is substantially equal to the output voltage V_{OUT}. Initially, at time T₁, transistor 206 is turned on and transistor 216 is turned off. Additionally, the inductor current feedback signal ISEN 302 is greater than the error amplifier 234 COMP signal 304. The output of the comparator 232 is “low” so that when the clock 242 generates a pulse on the clock signal 306, the buck flip-flop 224 is reset and transistor 206 is turned off. The inductor current decreases from time T₂ to time T₃ as does the ISEN signal 302 such that when the ISEN signal 302 becomes less than the COMP signal at time T₃, the comparator output goes “high” and the SR flip-flop 224 is set, turning on transistor 206. The output of the comparator 232 remains “high” so that when the next clock pulse is generated at time T₄, the boost SR flip-flop 226 is set and transistor 216 is turned on. The buck SR flip-flop 224 remains set with transistor 206 turned on. The inductor current and the ISEN signal 302 increase from time T₄ to time T₅ until the ISEN signal 302 becomes greater than the COMP signal 304. This causes the comparator output to go “low” and reset the boost flip-flop 226 turning off transistor 216 at time T₅. The cycle repeats at the next clock pulse when the comparator output goes low and transistor 206 is turned off.

Thus, using the error amplifier output COMP to control the inductor valley current in buck mode and the inductor peak current in boost mode, the transition between modes is smooth and natural when the input voltage falls below a point where the buck mode can no longer supply the load. The feedback loop moves the COMP signal to regulate the output in buck boost mode or boost mode as necessary.

Referring now to FIG. 6, there is illustrated an alternative embodiment of a control method for a buck boost regulator using an interleaved window buck boost regulator configuration. The input voltage V_{IN} is applied at node 602. A transistor 604 has its source/drain path connected between node 602 and node 606. A transistor 608 has its drain/source path connected between node 606 and ground. Inductor 610 is connected between node 606 and node 612. Transistor 614 has its drain/source path connected between node 612 and the output voltage V_{OUT} node 616. A capacitor 618 is connected between the output voltage node 616 and ground. Capacitor 620 has its drain/source path connected between node 612 and ground.

Error amplifier 622 has its inverting input connected to the output voltage node 616 to monitor the output voltage V_{OUT}. The error amplifier 622 has its non-inverting input connected to the reference voltage REF. The error amplifier 622 generates the error voltage signal (COMP) at its output to node 624. Node 624 is within a resistor string consisting of a resistor 626 connected between node 628 and node 630. A resistor 632 is connected between node 630 and node 624, and a resistor 634 is connected between node 624 and node 636. Finally, resistor 638 is connected between node 636 and node 640. A current source I_{W} 642 is connected between node 628 and node 640 in parallel with the resistor string. A voltage L3 is generated from node 630 and a voltage L2 is provided at node 636. Voltages L₁ and L₄ are also provided at nodes 640 and 628, respectively. The current source 642 and resistor ladder consisting of resistors 626, 632, 634 and 638 generate a variety of offset voltage signals at node 628, 630, 624, 636 and 640, respectively. These voltages are alternately applied via switches 648, 652, 662 and 666 to the non-inverting input of comparators 644 and 658. The offset voltages provided from the resistor ladder in combination with the comparator 622 enables the comparator 622 to be operated as a hysteretic comparator. A comparator 644 has its inverting input connected to sense the inductor current (ISEN) at node 606. The non-inverting input of comparator 644 is connected to node 646. A switch 648 connects the resistor ladder at node 628 to node 646 responsive to the BUCK signal at node 650. Switch 652 connects node 646 to node 636 of the resistor ladder responsive to the inverted BUCK signal.

The output of comparator 644 is connected to a first input of AND gate 656. The other input of AND gate 656 is connected to receive a clock signal CLK from an associated clock circuit. The output of AND gate 656 is connected to node 650. Node 650 connects to the inverting inputs of a pair of driver circuits 658 and 660. Node 658 drives the gate of transistor 604 while driver 660 drives the gate of transistor 608.

Comparator 658 has its inverting input connected to node 606 to receive the ISEN current measurement of the inductor current. The non-inverting input of comparator 658 is connected to node 660. A switch 662 connects node 630 to node 660 responsive to the BOOST signal from node 664. A switch 666 connects node 660 to node 640 responsive to the inverted BOOST signal.

In the buck mode of operation for the circuit of FIG. 6 a comparator 644 is set (i.e., its output going logic HIGH) responsive to the ISEN signal being less than the L2 voltage level. In the buck mode of operation (clocked mode) when RIPPLE is less than the L2 voltage level this turns on switch 604 and the CLK signal turns off switch 604. In the boost mode of operation (clocked mode) the CLK signal turns on transistor 620 and when RIPPLE is less that the L3 voltage level this turns off transistor 620. In the BUCK-BOOST mode of operation (clocked mode) has the same switching operations but alternate between the buck and boost modes.

The switches 648, 652, 662 and 666 apply the various voltages at nodes 628, 630, 636 and 640 to the non-inverting inputs of comparators 634 and 658 responsive to the BUCK signal at the output of AND gate 656 and the BOOST signal at the output of OR gate 670. When the BUCK signal is at a logical “0” level, switch 648 is opened and switch 652 is closed with applies the L2 voltage from node 636 to the non-inverting input of comparator 644. When the BUCK signal is at a logical “high” level, switch 648 is closed and switch 652 is open. This applies the L1 voltage from node 628 to the non-inverting input of comparator 644.

Similarly, when the BOOST signal is at a logical “low” level, switch 662 is opened and switch 666 is closed. This applies the L1 voltage from node 640 to the non-inverting input of comparator 658. When the BOOST signal is at a logical “high” level, switch 622 is closed and switch 666 is opened. This applies the L3 signal voltage node 630 to the non-inverting input of comparator 658.

Referring now to FIG. 7a, there is illustrated the operation of the circuit of FIG. 6 in the buck mode of operation when the input voltage V_{IN} at node 602 is greater than the output voltage V_{OUT} at node 616. Transistor Q3 614 is turned on in the buck mode of operation while transistor Q4 620 is turned off. The current sense signal ISEN 702 from node 606 oscillates between the L2 voltage level and an undefined level below the L4 voltage level derived from the COMP signal and resistor ladder. The ISEN signal 702 is increasing up to time T₁. Upon receipt of a clock signal at time T₁, the Q1 transistor 604 is turned off while transistor Q2 608 is turned on. This causes the ISEN signal at node 606 to begin decreasing from time T₁ to time T₂. At time T₂ when the ISEN voltage at node 606 reaches the L2 voltage level, transistor Q1 604 is turned back on and transistor Q2 608 is turned off. This causes the voltage signal ISEN at node 606 to begin again increasing until time T₃. The process then repeats itself in a similar manner.

Referring now to FIG. 7b, there is illustrated a buck mode of operation wherein a clock signal is not utilized within the circuit. In this mode of operation, the ISEN signal 702 oscillates all the way between the L2 voltage and the L4 voltage. When the ISEN signal 702 exceeds the L4 voltage at time T₁, transistor Q1 604 is turned off and transistor Q2 608 is turned on. This causes the ISEN voltage at node 606 to begin decreasing from time T₁ to time T₃. At time T₂ when the ISEN voltage falls below the L2 voltage, transistor Q1 604 is turned back on and transistor Q2 608 is turned off. The voltage at node 606 ISEN then begins increasing from time T₂ to time T₃. The process then repeats itself.

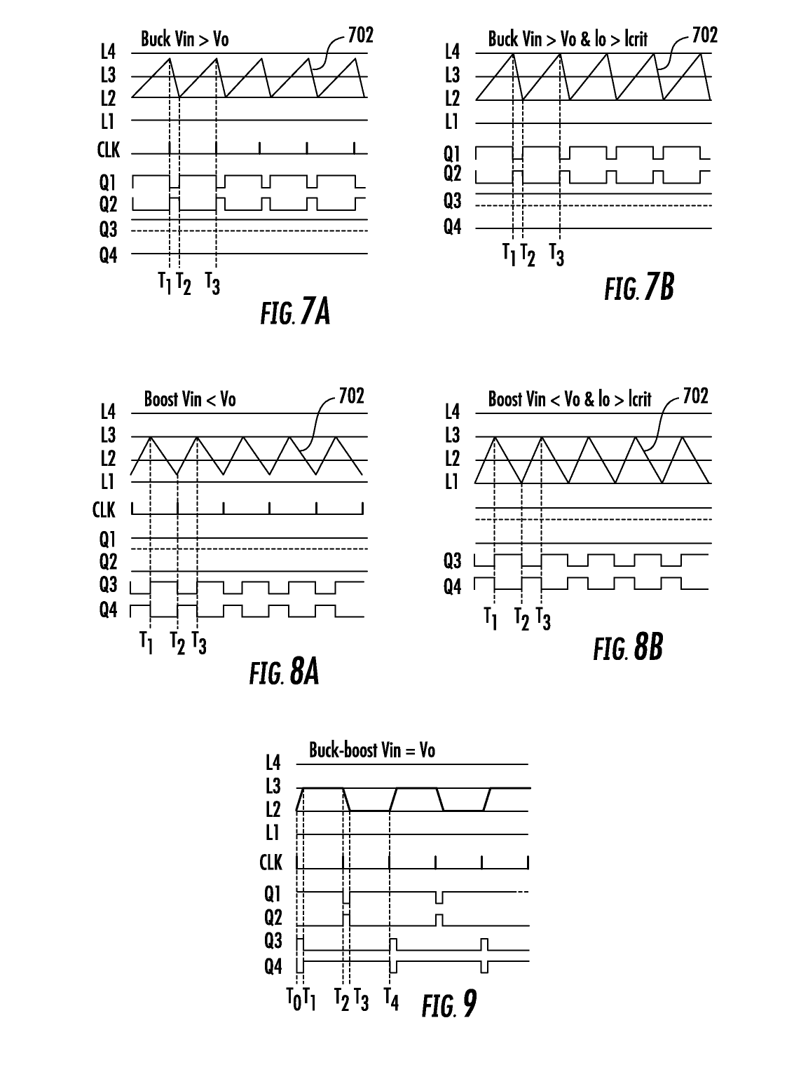

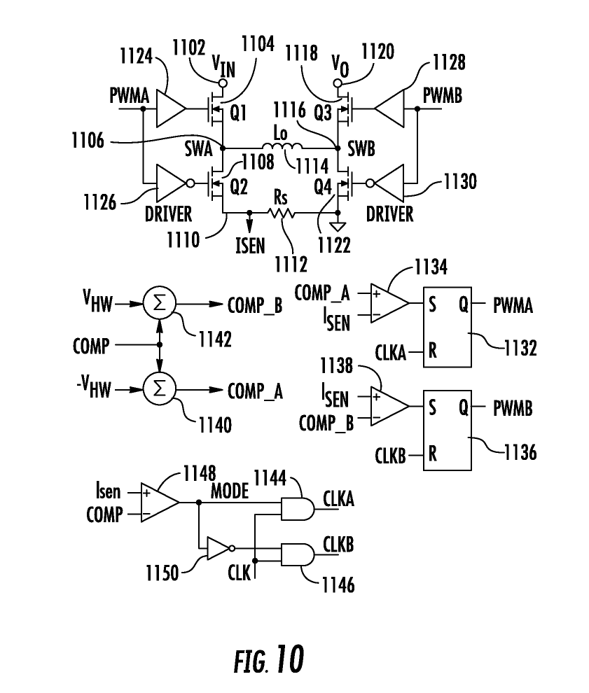

Referring now to FIG. 8a, there is illustrated the operation of the circuit of FIG. 6 in the boost mode of operation when the input voltage V_{IN} is less than the output voltage V_{OUT}. In the boost mode of operation, the ISEN signal 702 oscillates between an undefined level above the L1 voltage level and the L3 voltage level as illustrated in FIG. 8a. In the boost mode of operation, transistor Q1 604 is always turned on while transistor Q2 608 is always turned off. The ISEN signal 702 at node 606 increases up to time T₁, wherein it exceeds the L3 voltage level. This causes transistor Q3 614 to be turned on and transistor Q4 620 to be turned off. The ISEN signal at node 606 then begins decreasing until a next clock pulse is received at time T₂. Responsive to the clock pulse, transistor Q3 614 is turned off while transistor Q4 620 is turned on. This causes the ISEN signal 702 at node 606 to begin increasing from time T₂ to time T₃. When the ISEN signal 702 exceeds the L3 voltage at time T₃, transistor Q3 614 is again turned on and transistor Q4 620 is again turned off and the process repeats as described earlier.

Referring now to FIG. 8b, there is illustrated the operation of the buck boost converter of FIG. 6 when no clock signal is present. In this case, the ISEN signal 702 oscillates between the L1 voltage and the L3 voltage from the resistor ladder. At time T₁, when the ISEN voltage 702 exceeds the L3 voltage, transistor Q3 614 is turned on while transistor Q4 620 is turned off. This causes the ISEN voltage to decrease from time T₁ to time T₂. When the ISEN signal 702 falls below the L1 voltage, transistor Q3 614 is turned off and transistor Q4 620 is turned back on. This again causes the ISEN signal to begin increasing until it reaches the L3 voltage. This process will then repeat.

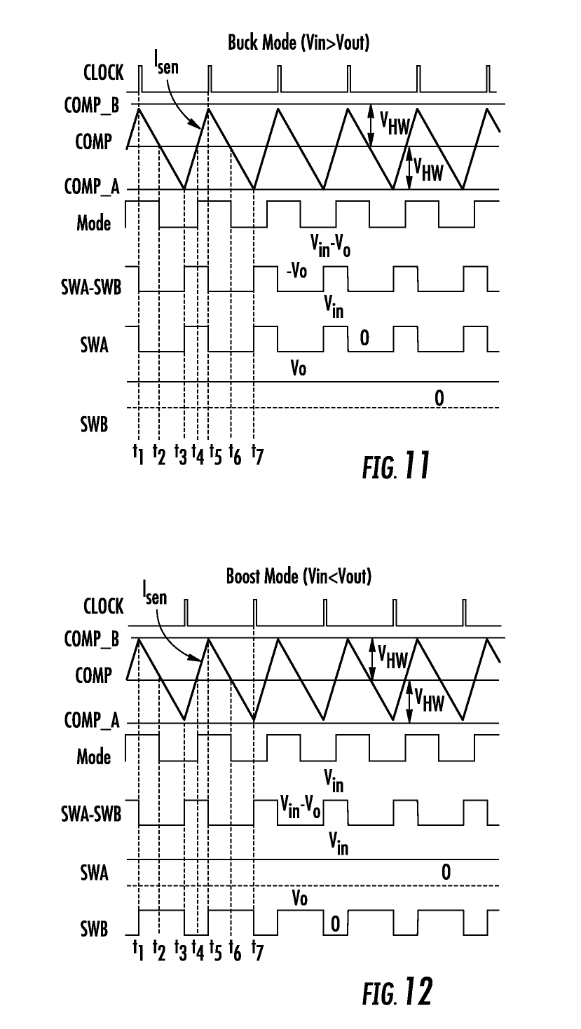

Referring now to FIG. 9, there is illustrated the buck boost mode of operation for the buck boost circuit of FIG. 6. In this case, both comparators 644 and 646 operate as described above. The logic of FIG. 6 forces alternating switching between the Q1, Q2, Q3 and Q4 transistors. Responsive to a clock pulse at time T₀, transistor Q3 614 is turned on while transistor Q4 620 is turned off. This causes the ISEN signal 702 to increase from time T₀ to time T₁. At time T₁ when the ISEN signal 702 reaches the L3 voltage level, the transistor Q3 614 is turned off while transistor Q4 620 is turned on. The ISEN voltage 702 will remain substantially the same from time T₁ to time T₃ due to the input voltage V_{IN} being substantially equal to the output voltage or the voltage across the inductor being near zero. Responsive to a next clock pulse at time T₂, transistor Q1 604 is turned off while transistor Q2 608 is turned on. This causes the ISEN signal 702 to decrease from time T₂ to time T₃ until the ISEN signal 702 equals the L2 voltage. When ISEN 702 equals the L2 voltage, transistor Q1 604 is turned back on and transistor Q2 608 is turned off. This causes the ISEN voltage to remain at the L2 level from time T₃ to time T₄ due to the input voltage V_{IN} being substantially equal to the output voltage or the voltage across the inductor being near zero. Responsive to a next clock pulse at time T₄, the process repeats as described above.

Referring now to FIG. 10, there is illustrated yet a further embodiment of a modulation scheme for use with a buck boost converter. The input voltage V_{IN} is applied at node 1102. A transistor 1104 has its drain/source path connected between node 1102 and node 1106. A switching transistor 1108 has its drain/source path connected between node 1106 and node 1110. A resistor 1112 is connected between node 1110 and ground.

An inductor 1114 is connected between node 1106 and node 1116. A switching transistor 1118 has its drain/source path connected between node 1120, the output voltage node, and node 1116. A transistor 1122 has its drain/source path connected between node 1116 and ground. The gate of transistor 1122 is connected to the output of a driver 1124 responsive to a PWM A control signal. An inverting driver 1126 drives the gate of transistor 1108 responsive to the PWM A control signal. A driver 1128 has its output connected to drive the gate of transistor 1118 responsive to a PWM B control signal. An inverting driver 1130 drives the gate of transistor 1122 responsive to the PWM B control signal.

The PWM A control signal is generated from an SR latch 1132. The R input of the SR latch 1132 is connected to receive the CLKA clock signal. The S input of the SR latch 1132 is connected to the output of a comparator 1134. The inverting input of the comparator 1134 is connected to receive the ISEN signal from node 1110. The non-inverting input of comparator 1132 is connected to receive the COMP_A error signal as will be more fully described herein below.

The PWM B control signal is generated from SR latch 1136. The R input of SR latch 1136 is connected to receive the CLKB clock signal while the S input of the SR latch is connected to the output of a comparator 1138. The inverting input of comparator 1138 receives the COMP_B error signal while the non-inverting input is connected to the ISEN signal at node 1110.

The COMP_A and COMP_B signals are generated at the outputs of summation circuits 1140 and 1142, respectively. The COMP signal from the error amplifier is applied to each of summation circuits 1140 and 1142. Within summation circuit 1140 the COMP signal is added to the offset voltage −V_{HW} to generate the COMP_A error signal. The offset voltage for the summation circuits 1140 is developed in the same manner illustrated with respect to FIG. 6. The current source 642 flows through the resistor 626 to develop the offset voltage V_{HW}. A different offset voltage is obtained by adjusting the current source or the value of resistor 626. Similarly, within summation circuit 1142, the COMP signal is added with offset voltage V_{HW} to generate the COMP_B signal. The summation circuits 1140 and 1142 add an offset of −V_{HW} and +V_{HW}, respectively, to the voltage error signal COMP. The COMP signal having the offset −V_{HW} deducted therefrom provides the signal COMP_A. The summation circuit 1142 combines the COMP signal with V_{HW} to provide the COMP_B signal.

The CLKA and CLKB clock signals are generated at the outputs of AND gates 1144 and 1146, respectively. The first input of AND gate 1144 is connected to receive the CLK clock signal. The other input of AND gate 1144 is connected to receive a mode signal from the output of a comparator 1148. The inverting input of comparator 1148 is connected to receive the error voltage signal COMP. The non-inverting input is connected to receive the ISEN signal from node 1116. The CLKB clock signal provided from AND gate 1146 is provided responsive to the CLK clock signal being applied to a first input of AND gate 1146 and an inverted version of the mode signal output from comparator 1148 being applied through an inverter 1150 to the other input of the AND gate 1146.

The COMP_A signal is compared with the ISEN signal from node 1110 within comparator 1134 the output of the comparator is provided to the S input of the SR latch 1132 to generate the PWM A signal. Likewise, the ISEN signal from node 1110 is compared with the COMP_B signal at node 1138 to generate an input to the S input of SR latch 1136 to provide the PWM B output. The CLKA signal is applied to the R input of SR latch 1132. The CLKB signal is applied to the R input of SR latch 1136.

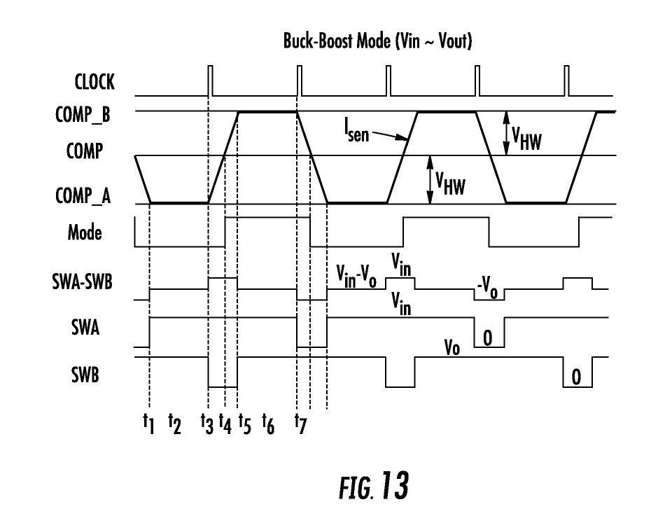

Referring now to FIG. 11, when the ISEN signal is always lower than (i.e. never reaches) COMP_B the buck boost regulator enters the buck mode of operation. When the ISEN signal intersects the COMP signal at time T₄ when ISEN first exceeds COMP, the MODE signal from the output of comparator 1148 goes “high” enabling the generation of the CLKA signal at the next clock pulse for latch 1132. Upon occurrence of the next clock pulse at time T₅, transistor 1104 turns off and transistor 1108 is turned “on” causing the ISEN current at node 1110 to begin to drop. At time T₆, the ISEN signal drops below the COMP signal. This causes the MODE signal from the output of comparator 1148 to be reset to zero. Next, at time T₇, the ISEN signal drops below the lower window voltage COMP_A which causes transistor 1104 to be turned back on and transistor 1108 to turn off. This causes the ISEN signal to begin increasing, and the above procedure repeats. Within the buck mode of operation, the ISEN ramp never reaches the COMP_B level and the transistor 1118 is always turned on to hold the SWB node 1116 at the output voltage V_{OUT}.

Referring now to FIG. 12, there is illustrated the boost mode of operation when the ISEN signal is always higher than (i.e. never reaches or falls below) COMP_A. When the ISEN signal falls below the COMP signal at, for example, time T₂, the mode signal from the output of comparator 1148 goes “low” enabling the generation of the CLKB signal at the next clock pulse for latch 1136. Upon occurrence of the next clock boost at time T₃, transistor 1122 is turned “on.” This causes ISEN to begin to increase. At time T₄, the ISEN signal goes above the COMP signal and the MODE signal is set to one. When the ISEN signal goes above the upper window COMP voltage COMP B at time T₅, this will set latch 1136, terminate the PWM signal and turn off transistor 1122. This causes ISEN to begin decreasing. The process then repeats. Within the boost mode of operation, the ISEN ramp never reaches the COMP_A level and transistor 1104 is always turned on to hold the SWA node 1116 at the input voltage V_{IN}.

Referring now to FIG. 13, there is illustrated the buck boost mode of operation when V_{IN} is approximately equal to V_{OUT}. In the buck boost mode of operation the buck boost regulator will run in the buck mode in one cycle and in the boost mode in the next cycle while the MODE signal from the output of comparator 1148 jumps between the “zero” and “one” values during two cycles. On the left side of the illustration in FIG. 13 before time T₄, the ISEN signal is below the COMP signal causing the MODE signal from the output of comparator 1148 to be set to a “low” value. The MODE signal is toggling in every cycle (in both buck and boost modes. The MODE signal is used to generate the buck clock (CLKA) and the boost clock (CLKB) from the CLK signal. The state of the Mode signal, at the time when the clock (CLK) happens decides whether the converter is buck or boost mode (or buck-boost mode when the logic value of Mode changes at every clock signal). When the ISEN signal drops below the COMP A signal at time T₁, the PWM A output from SR latch 1132 is set to turn “off” transistor 1108 pulling the SWA node 1106 to the input voltage V_{IN}. Since the SWB node 1116 is pulled to the output voltage V_{OUT}, which is almost equal to the input voltage V_{IN}, the ISEN signal may remain constant from time T₁ to time T₃. When the next clock signal occurs at time T₃, the MODE signal at the output of comparator 1148 goes to “zero” which causes transistor 1122 to be turned “on.” This pulls the SWB node 1116 to “zero.” ISEN will then begin increasing at time T₃ to time T₅.

At time T₄, the ISEN signal goes above the COMP signal. This causes the MODE signal to go to a logical “high” value. At time T₅ the ISEN signal goes above the upper window voltage COMP B which terminates the PWM signal to transistor 1122 turning off transistor 1122. The SWA node 1106 is pulled to the input voltage V_{IN} and the SWB node 1116 is pulled to the output voltage V_{OUT}. Since the input voltage and output voltage are substantially equal, the ISEN signal will remain relatively constant between times T₅ to time T₇. When the next clock signal occurs at time T₇, the mode signal will be set to a logical “high” value turning transistor 1108 on and causing ISEN to begin to decrease. The above described procedure will then repeat.

It will be appreciated by those skilled in the art having the benefit of this disclosure that this modulation scheme for a constant frequency buck boost converter provides improved control of buck boost converters. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An apparatus comprising:
a buck boost converter for generating an output voltage responsive to an input voltage and at least one switching control signal in a buck mode of operation, a boost mode of operation and a buck-boost mode of operation;
control logic for generating the at least one switching control signal responsive to the output voltage, a reference voltage, and a sensed voltage associated with an inductor current of the buck boost converter; and
wherein the sensed voltage associated with the inductor current enables the control logic to generate the at least one switching control signal in a selected one of the buck mode of operation, the boost mode of operation and the buck-boost mode of operation.

2. The apparatus of claim 1, wherein the control logic further comprises:
an error amplifier for generating an error voltage responsive to the output voltage and the reference voltage;
a comparator for generating a mode selection signal selecting one of the buck mode of operation and the boost mode of operation responsive to the error voltage and the sensed voltage associated with the inductor current; and
control signal circuitry for generating the at least one switching control signal responsive to the mode selection signal and a clock signal.

3. The apparatus of claim 2, wherein the at least one switching control signal further comprises a buck switching control signal for selectively switching a first power transistor in the buck mode of operation and a boost switching control signal for selectively switching a second power transistor in the boost mode of operation, further wherein each of the buck switching control signal and the boost switching control signal switches each of the first and the second power transistors in the buck-boost mode of operation.

4. The apparatus of claim 2, wherein the control signal circuitry further comprises:
first logic circuitry for generating a first control signal responsive to the mode selection signal and the clock signal;
a first latch circuit for generating a buck switching control signal responsive to the mode selection signal and the first control signal;
second logic circuitry for generating a second control signal responsive to the mode selection signal and the clock signal; and
a second latch circuit for generating a boost switching control signal responsive to an inverted mode selection signal and the second control signal.

5. The apparatus of claim 1 further including a current sensor for monitoring the inductor current through an inductor of the buck boost converter and generating the sensed voltage responsive thereto.

6. The apparatus of claim 1, wherein the control logic further comprises:
an error amplifier for generating an error voltage responsive to the output voltage and the reference voltage;
a resistor ladder connected to an output of the error amplifier;
a current source connected across the resistor ladder;
wherein responsive to the current source a plurality of voltage levels are generated at a plurality of nodes of the resistor ladder;
first control logic for generating a buck control signal for controlling switching of at least one first switching transistor associated with the buck mode of operation responsive to the sensed voltage and at least one voltage from the resistor ladder; and
second control logic for generating a boost control signal for controlling switching of at least one second switching transistor associated with the boost mode of operation responsive to the sensed voltage and at least one voltage from the resistor ladder.

7. The apparatus of claim 6 wherein the first control logic further comprises first and second switches for applying a first voltage from the resistor ladder to the first control logic responsive to the buck control signal in a first state and for applying a second voltage from the resistor ladder to the first control logic responsive to the buck control signal in a second state.

8. The apparatus of claim 6 wherein the second control logic further comprises first and second switches for applying a third voltage from the resistor ladder to the second control logic responsive to the boost control signal in a first state and for applying a second voltage from the resistor ladder to the second control logic responsive to the boost control signal in a second state.

9. The apparatus of claim 1 wherein the control logic further comprises:
an error amplifier for generating an error voltage responsive to the output voltage and the reference voltage;
summation circuitry for generating a first error voltage responsive to the error voltage and a positive offset value and for generating a second error voltage responsive to the error voltage and negative offset value;
a comparator for determining a mode signal responsive to the sensed voltage and the error voltage;
clock logic circuitry for generating a first clock signal and a second clock signal responsive to the a clock signal and the mode signal;
buck driver circuitry for generating buck drive signals for buck switching transistors of the buck boost converter, comprising:
a first comparator for comparing the first error voltage with the sensed voltage;
a first latch for generating the buck drive signal responsive to an output of the first comparator and the first clock signal;
boost driver circuitry for generating boost drive signals for boost switching transistors of the buck boost converter, comprising:
a second comparator for comparing the second error voltage with the sensed voltage;
a second latch for generating the boost drive signal responsive to an output of the second comparator and the second clock signal.

10. An apparatus comprising:
a buck boost converter for generating an output voltage responsive to an input voltage and at least one switching control signal in a buck mode of operation, a boost mode of operation and a buck-boost mode of operation;
a current sensor for monitoring the inductor through an inductor of the buck boost converter and generating a sensed voltage responsive thereto;
an error amplifier for generating an error voltage responsive to the output voltage and a reference voltage;
a comparator for generating a mode selection signal selecting one of a buck mode of operation and a boost mode of operation responsive to the error voltage and the sensed voltage associated with the inductor current; and
control signal circuitry for generating the at least one switching control signal responsive to the mode selection signal and a clock signal;
wherein the sensed voltage associated with the inductor current enables the control signal circuitry to generate the at least one switching control signal in a selected one of the buck mode of operation, the boost mode of operation and the buck-boost mode of operation.

11. The apparatus of claim 10, wherein the at least one switching control signal further comprises a buck switching control signal for selectively switching a first power transistor in the buck mode of operation and a boost switching control signal for selectively switching a second power transistor in the boost mode of operation, further wherein each of the buck switching control signal and the boost switching control signal switches each of the first and the second power transistors in the buck-boost mode of operation.

12. The apparatus of claim 10, wherein the control signal circuitry further comprises:
first logic circuitry for generating a first control signal responsive to the mode selection signal and the clock signal;
a first latch circuit for generating a buck switching control signal responsive to the mode selection signal and the first control signal;
second logic circuitry for generating a second control signal responsive to the mode selection signal and the clock signal; and
a second latch circuit for generating a boost switching control signal responsive to an inverted mode selection signal and the second control signal.

13. A method for selecting a mode of operation of a buck boost converter, comprising the steps of:
generating an output voltage responsive to an input voltage and at least one switching control signal in a buck mode of operation, a boost mode of operation and a buck-boost mode of operation;
generating the at least one switching control signal responsive to the output voltage, a reference voltage, and a sensed voltage associated with an inductor current of the buck boost converter in a selected one of the buck mode of operation, the boost mode of operation and the buck-boost mode of operation.

14. The method of claim 13, wherein the step of generating the at least one control signal further comprises the steps of:
generating an error voltage responsive to the output voltage and the reference voltage;
generating a mode selection signal selecting one of the buck mode of operation and the boost mode of operation responsive to the error voltage and the sensed voltage associated with the inductor current; and
generating the at least one switching control signal responsive to the mode selection signal and a clock signal.

15. The method of claim 14 further comprising the steps of:
selectively switching a first power transistor in the buck mode of operation responsive to a buck switching control signal;
selectively switching a second power transistor in the boost mode of operation responsive to a boost switching control signal; and
selectively switching each of the first and the second power transistors in the buck-boost mode of operation responsive to each of the buck switching control signal and the boost switching control signal.

16. The method of claim 14 further including the steps of:
generating a first control signal responsive to the mode selection signal and the clock signal;
generating a buck switching control signal responsive to the mode selection signal and the first control signal;
generating a second control signal responsive to the mode selection signal and the clock signal; and
generating a boost switching control signal responsive to an inverted mode selection signal and the second control signal.

17. The method of claim 13 further including the step of monitoring the inductor current through an inductor of the buck boost converter and generating the sensed voltage responsive thereto.

18. The method of claim 13 further including the steps of:
generating a plurality of voltage levels at a plurality of nodes of the resistor ladder responsive to a current source and an error voltage from an error amplifier;
generating a buck control signal for controlling switching of at least one first switching transistor associated with the buck mode of operation responsive to the sensed voltage and at least one of the plurality of voltage levels from the resistor ladder; and
generating a boost control signal for controlling switching of at least one second switching transistor associated with the boost mode of operation responsive to the sensed voltage and at least one of the plurality of voltage levels from the resistor ladder.

19. The method of claim 18 wherein the step of generating the buck control signal further comprises the steps of:
applying a first voltage from the resistor ladder responsive to the buck control signal in a first state; and
applying a second voltage from the resistor ladder responsive to the buck control signal in a second state.

20. The method of claim 19 wherein the step of generating the boost control signal further comprises the steps of:
applying a third voltage from the resistor ladder responsive to the boost control signal in a first state; and
applying a second voltage from the resistor ladder responsive to the boost control signal in a second state.

21. The method of claim 13 wherein the step of generating further comprises the steps of:
generating an error voltage responsive to the output voltage and the reference voltage;
summing the error voltage and a positive offset value to generate a first error voltage;
summing the error voltage and negative offset value to generate a second error voltage;
comparing the sensed voltage and the error voltage to determine a mode signal, wherein the mode signal indicates the buck mode of operation or the boost mode of operation;
generating a first clock signal and a second clock signal responsive to the a clock signal and the mode signal;
comparing the first error voltage with the sensed voltage;
generating the buck drive signal responsive to the step of comparing and the first clock signal;
comparing the second error voltage with the sensed voltage;
generating the boost drive signal responsive to the step of comparing and the second clock signal.
